(19) United States
(12) Patent Application Publication
(10) Pub. No.: US 2012/0094176 A1
(43) Pub. Date: Apr. 19, 2012

(54) Power-Optimized And Energy-Density-Optimized Flat Electrodes For Electrochemcal Energy Stores

(76) Inventors: Gerold Neumann, Halstenbek (DE); Andreas Wuersig, Itzehoe (DE); Peter Gulde, Itzehoe (DE)

(21) Appl. No.: 13/148,701

(22) PCT Filed: Feb. 9, 2010
(86) PCT No.: PCT/EP10/51598

§ 371 Date: Nov. 12, 2011

(30) Foreign Application Priority Data
Feb. 10, 2009 (DE) 10-2009-008-311.1
Jul. 23, 2009 (EP) 09009558.9

(51) Int. Cl. H01M 4/70; H01M 4/62; B05D 1/36; H01M 4/04; B32B 37/06; B32B 37/10; H01M 4/02; H01M 2/14

(52) U.S. Cl. 429/211; 429/209; 429/217; 429/246; 156/306.3; 156/308.2; 427/402

(57) ABSTRACT

The invention relates to an electrode layer composite for forming planar electrodes (1, 2) in electrochemical storage elements, wherein the electrode layer composite comprises at least one first layer (6, 8) containing electrode material and one second layer (7, 9) containing electrode material, wherein the first layer (6, 8) has a higher energy density (specific or area capacity) than the second layer (7, 9), while the second layer (7, 9) has a higher power density (current carrying capability) per unit area than the first layer (6, 8).

The present invention concerns an electrode layer composite for forming flat electrodes in electrochemical storage elements such as batteries and accumulators, an electrochemical storage element for storage as well as delivery of electrical energy with a flat anode, a separator, and a flat cathode, comprising such an electrode layer composite, as well as a method for producing such electrode layer composites and storage elements provided therewith.

Electrochemical storage elements, constructed of flat electrode and separator layers, in particular on the basis of film technologies, are known in general. They have as electrodes flat anodes and cathodes that are separated from each other by a separator and each are connected with a current conductor by means of which contacting is realized. In lithium ion cells the films in general are processed to a multi-layer coil body and pressed into a rigid metal housing. Into the latter, the liquid electrolyte is then introduced and, subsequently, the battery housing is hermetically sealed. Lithium polymer cells are flat cells that are also referred to as prismatic cells. Here, the electrodes, usually in the form of films, are typically stacked and under pressure and optionally temperature application or by means of adhesives are intimately connected with each other. The battery body is then introduced into a housing, in general a metallized plastic film, filled with electrolyte and then closed off by sealing off the rim of the housing film. Upon final closure, a vacuum is produced in the interior of the housing. In this cell type, the electrolyte is incorporated in the battery body into micropores that exist in the electrode and separator structure or, by gel formation of the polymer binder, is absorbed and immobilized in the layers.

The electrochemically active materials for electrode films are in general powders and have a certain particle size distribution. They are processed by means of binder to films. In U.S. Pat. No. 5,219,680 A, for example, a carbon polymer electrode as anode, comprised of amorphous carbon particles embedded in a polymer matrix, is described.

In order to produce the ionic conductivity between the carbon particles in the electrode, the anode is filled with a liquid electrolyte. The latter is received in pores or in the polymer matrix. Materials for the cathode, for example, LiCoO₂, are converted into films in a manufacturing technologically comparable way as described in U.S. Pat. No. 5,219,680 for the anode.

Various manufacturing ways are known for separators. For example, there is the possibility to produce a gel from the liquid electrolytes and to process them thus into films. Such an approach is disclosed, for example, in the patent U.S. Pat. No. 5,009,970. Another procedure resides in that a film with a fine-pore sponge structure is produced and then, after completion of the film composite, is made ionically conductive by impregnation in a liquid electrolyte. This method is disclosed in patent U.S. Pat. No. 5,464,000. DE 198 39 217 A1 discloses a possibility to incorporate a solid ion conductor into a polymer matrix and to thereby produce a separator film.

Pasty materials, electrodes and solid state electrolytes in lithium technology as well as electrochemical cells, in particular accumulator cells, produced by using these materials are disclosed inter alia in WO 00/13249, WO 00/63984, WO 01/33656 A1, and WO 01/41246 A1.

Electrochemical energy storage devices on the basis of lithium accumulators have reached a very large economic significance. Currently, they are viewed as one of the most promising options for introduction of hybrid vehicles or even completely electrically operated vehicles. In this connection, the energy storage devices must fulfill numerous requirements. While in consumer applications the primary focus is on a high volumetric and gravimetric energy density, in vehicle applications inter alia quick charge capability and high pulse capacity as well as high power density and a broad temperature range for use as well as a high inherent safety are to be taken into account also.

In particular the requirements of a high power density, for example, high pulse capacity, and high gravimetric as well as volumetric energy density cannot be realized simultaneously in a storage cell or for an electrode, according to the prior art. This is to be explained by way of example of a lithium accumulator:

In such a device, lithium ions, under the effect of an electrical field impressed externally, are moved from the cathode through the separator to the anode during the charging process. The separator as a separating layer between the anode and cathode is purely ion-conducting so that electrodes can only follow the path through the outer current circuit to the anode in order to maintain the charge balance in the accumulator. This requires therefore that within the electrodes, across their layer thickness up to the phase boundary that is facing the separator, an excellent ion and electron conductivity must be ensured.

The electronic and ionic conductivities in the structure of the electrochemical storage element is based on various mechanisms with different values for conductivity and optionally temperature dependency. In this connection, there are material-dependent contributions, such as particle size of the electrode material, as well as proportions that are determined by the cell design, such as dimensions of the electrode. By selecting the material morphology as well as by cell design, the cells however can be configured only either toward achieving a high loadability (in accordance with minimal inner resistance) or toward achieving a high energy density.

During charging or discharging processes, lithium atoms as ions are reversibly incorporated into or removed from the lattice structure of the solid-state particles of the electrochemically active material in a battery or accumulator configuration. They migrate in the solid-state body to the surface of the particle by solid-state diffusion. Since lithium ions are moved within the solid-state body, for reasons of charge neutrality additionally also a satisfactory electronic conductivity is required that in general significantly deviates from the ionic conductivity. Based on the example of data of conductivities of the cathode material LiCoO₂, the problem to be solved will become apparent:

Electronic conductivity: 0.43 to 4,800 mS/cm (depending on the charge state)
Ionic conductivity: approximately 3*10⁴ mS/cm.

The indicated conductivities relate to mobility of the electrons or ions in the active material particles of the electrode material. For use in a cell in general a total conductivity of the cell of at least 1 to 10 mS/cm is required. The required conductivities can be produced by addition or admixture of conductivity improving substances such as carbon black for the electronic conductivity and of electrolyte for the ionic conductivity.

The conductivity-improving substances act however only outside of the solid-state particles, i.e., only once the ion or the electron has moved from the solid-state body into the surrounding matrix of soot and electrolyte. Since the solid-state diffusion is slower than diffusion in the surrounding matrix, a high power density is favored by short travel distances in the solid-state body, i.e., a particle size that is as small as possible. Moreover, a high power density is also favored by short travel distances in the matrix. Highly loadable electrodes, i.e., electrodes with a high power density have therefore in general an electrode material with small particle diameters down to the nanometer range as well as additionally minimal electrode sizes or thicknesses.

Materials with small particle sizes require in general during processing to battery electrodes a high binder proportion in order to ensure mechanical adhesion of the electrode. Since binders in the electrode represent a substantially inactive substance, the energy density of the cell is reduced by a high binder proportion relative to active material. When for achieving a desired target capacity a larger number of cell elements of a certain thickness are connected in parallel, a higher reduction of the energy density is observed in comparison to thicker electrodes because comparatively much separator material and metallic current conductors must be processed within the cell that, in relation to the storage capacity of the cell, represent dead material. As a whole, a highly loadable electrode according to the prior art leads to reduced energy density.

A high energy density can be favored by a high thickness of the electrode as well as large particle diameters of the active materials in accordance with a high active material proportion in the composite electrode because the electrode in this way may contain larger quantities of charge carriers so that its storage capacity is increased. A high electrode thickness as well as large particle diameters however cause greater travel distances for the electrons and ions so that, in turn, the power density is reduced.

The afore described incompatibility of high loadability, i.e., high power density, and simultaneous maintaining of a high energy density in the electrochemical storage element is solved in accordance with the prior art in that, for example, accumulators of high energy density are paired either with so-called super capacitors (supercaps), characterized by a very minimal energy density but extremely high power density, or with accumulators that are optimized with respect to high power density. The disadvantage of a configuration with supercaps is that the discharge characteristic lines of accumulators and supercaps differ significantly so that in general an adaptation must be realized by means of electronics. Such an arrangement is disclosed, for example, in EP 1 391 961 A1. However, this means undesirable expenditure with respect to electronics. Parallel connections of high energy and high power cells are also disclosed in various publications, for example, in WO 03/088375 A2 as well as in WO 03/088375 A2. Here, expensive electronic compensation circuits are required also.

Based on the afore described prior art, the present invention has the object to provide a flat electrode, in particular an electrode film, as well as an electrochemical energy storage device that enables simultaneously a high volumetric as well as gravimetric energy density as well as a high pulse power density and quick discharge or charge capability, without requiring for this purpose additional external measures such as electronic circuits.

The solution of the above described object resides with respect to the device in an electrode layer composite for forming in particular film-shaped electrodes in electrochemical storage elements that has at least one first layer and a second layer wherein the first layer (“high energy layer”) has a higher energy density and thus a higher capacity per surface area (mAh/cm²) than the second layer while the second layer (“high power layer”) has a higher power density and thus a higher current carrying capacity (mA/cm²) in comparison to the first layer.

It is solved furthermore by an electrochemical storage element for storage as well as delivery of electrical energy with a flat, in particular film-shaped, anode, a separator, and a flat, in particular film-shaped, cathode, wherein the anode and/or the cathode comprises or comprise a layer composite according to the invention.

With respect to the method, the object is solved by a method for producing a flat electrode according to the invention or an electrochemical storage element according to the invention, in which the first layer and the second layer are in particular produced separately and laminated by pressure and temperature application or in that first one of the two layers is deposited by a tape casting process on a substrate and the other layer is subsequently deposited by another tape casting process onto the first layer. Such an electrode configuration is advantageously connected to a metallic current conductor. The latter exits, for example, as a preferably primed foil that can be used as a substrate for the coating process or that can be connected by lamination with a double layer electrode. In another embodiment, a preferably primed open-pore current conductor is introduced between the high energy layer and the high power layer. In this configuration it is beneficial when the open-pore structure has a proportion of open surface area of at least 50%.

A flat electrode in the meaning of the present invention is to be understood as flat electrode bodies or flat materials in planar or curved shape. The films can be flexible as well as inflexible (in the latter case rigid or bendable only with difficultly). The “flat materials” or “flat bodies” are to be understood as materials according to the invention whose length and width have a significantly greater size than their thickness, i.e., their size in both areal directions is at least twice, and in general at least in one direction of the surface plane at least 10 times, preferably at least 100 times or even at least 1,000 times, the thickness diameter. Film materials are usually flexible.

The present invention concerns electrochemical energy storage devices, in particular in the form of flat (also stacked) or coiled batteries and accumulators that have flat, in particular film-shaped, electrodes, in particular lithium-ion cells and lithium polymer cells. In both cases, the flat bodies serve as a starting material for the electrodes as well as the separator that separates the anode and cathode from each other. As cathode materials for electrodes in lithium batteries or lithium accumulators several materials are available. As examples of cathode materials the following should be mentioned: LiCoO₂, LiMn₂O₄, LiMePO₄ (Me: metal, e.g. Fe, Co), LiNiO₂, LiMnₓNi_{y}Co_{z}O₂ (x+y+z=1), LiNiₓCo_{y}O₂ (x+y=1), V₂O₅ as well as LiAl₄Ni_{y}Co_{z}O₂ (x+y+z=1). A person of skill in the art will know additional materials. As anode materials for film electrodes in lithium batteries or lithium accumulators there are also numerous materials available. As examples for anode material graphite should be mentioned, preferably in different modifications, hard carbons, tin compounds, silicon, metallic lithium, TiO₂, Li₄Ti₅O₁₂ as well as mixtures thereof. A person of skill in the art will know additional materials. The materials are produced as powders of a certain particle size distribution. Of these powders, in general by embedding in a binder, a layer is formed from which, in a battery or accumulator configuration, lithium can be reversibly incorporated or removed.

As a binder all materials known in the prior art are suitable. Suitable are solvent-free, in particular however solvent-containing and/or swelling agent-containing binders. Especially suitable are fluorinated hydrocarbon polymers such as Teflon, polyvinylidene fluoride (PVDF) or polyvinylchloride. Films or layers that are produced with these binders have particularly excellent water-repellent action which imparts to the electrochemical components produced therewith a particular excellent long-term stability. Further examples are polystyrene or polyurethane. As examples of copolymers, copolymers of Teflon and amorphous fluoropolymer as well as polyvinylidene fluoride/hexafluoro propylene should be mentioned. Independent of whether the binder contains a solvent and/or swelling agent or not, a plasticizer (also called softening agent) may be present for the employed polymer material(s). The “plasticizer” is to be understood as substances whose molecules by auxiliary valency (van-der-Waals forces) are bonded to the polymer molecules. They reduce the interactive forces between the macromolecules and therefore reduce the softening temperature and brittleness and hardness of the plastic materials. However, as a result of their minimal volatility, they usually cannot be removed by evaporation from the plastic material but, if needed, must be removed by an appropriate solvent. The incorporation of a plasticizer causes a high mechanical flexibility of the films produced therewith.

As a further binder, for example, also synthetic rubbers such as SBR (styrene butadiene rubber) or CMC (carboxymethyl cellulose) or mixtures of both are conceivable. They are soluble in water.

However, there are special situations in which a binder can be completely eliminated, for example, when the solid particles for the electrode or solid state electrolyte material have a satisfactory cohesion, as may be the case for some nanoparticles, see WO 00/63984. The layer or film is then formed from a paste that is comprised of the nanoparticles in a suitable suspension agent.

The invention provides a novel concept for the configuration of flat electrodes and electrochemical energy storage devices as well as for manufacturing methods for such energy storage devices with which in a single component simultaneously high energy densities and high power densities can be achieved. Fulfilling these two properties in a single component is of great importance for energy storage devices, for example, in hybrid vehicles. High weight-based energy densities enable great vehicle travel distances by purely electric driving mode by means of weight reduction. Space savings in the vehicle are achieved by a reduced volume and a high power density enables good recuperation properties in braking operation and high loadability during acceleration. The high power density demand on the cells occurs thus primarily in pulse operation.

Such pulse profiles with simultaneous high energy density of the cell is thus accommodated by the invention.

For this purpose, the electrodes have at least two partial areas or layers with different properties. The first partial area or the first layer is designed for high energy density and is referred to as high energy layer. The second partial area or the second layer is designed for high power density and is referred to as high power layer. In particular, the first layer has a higher energy density than the second layer while the second layer has a higher power density than the first layer. The first layer represents as a result of its relatively high energy density a greater storage volume of the electrode for charge carriers. As has been explained above, the first layer however has only a relatively minimal power density. The latter is provided however by the second layer that however has a relatively minimal energy density. By combination of both layers a film-shaped electrode is provided that in an advantageous way has a high power density as well as a high energy density.

Short-term high loads (pulse operation) are buffered primarily by charge carrier displacements in the high power layer, long lasting uniform loads by charge carrier displacements in the high energy layer. When in pulse operation a stronger discharge of the high power layer in relation to the high energy layer occurs, this imbalance is compensated by charge carrier exchange between the high energy layer and the high power layer.

According to one embodiment of the invention, the first layer (high energy layer) has a greater layer thickness than the second layer (high power layer). Alternatively or in addition, the first layer comprises an electrode material that has a greater particle diameter than the electrode material of the second layer. The composite electrode that is made thereof contains thus a highly loadable part with electrode materials with particle diameters as small as possible and a minimal layer thickness as well as a different part with high energy density that in general has large particle diameters and a layer thickness as high as possible.

The electrode material of the two layers can be chemically different; preferably, however, it is comprised of the same chemical composition.

Suitable particle diameters (average primary particle size at minimal agglomeration state) of the electrode material for the high energy layer lie advantageously in a range of approximately 0.5-10 μm, preferably at approximately 0.7-6 μm. The particle diameters for the high power layer are advantageously in a range of approximately 1 nm to 1 μm, preferably approximately 50-700 nm. The ratio of particle diameters of high energy material to high power material is in general in the range of 1.2:1 to 20:1. Often, a ratio of 1.5:1 to 7.5:1 and especially preferred of approximately 5:1 will be selected.

An electrochemical storage element according to the invention for storage and delivery of electrical energy comprises an anode, a separator, and a cathode, wherein anode and/or cathode comprises at least one layer composite according to the invention, as described herein. As is well known, anode as well as cathode are connected to current collectors by means of which exterior contacting is realized. The electrodes have a finite thickness, respectively, that is typically between approximately 50 μm and 200 μm, contain inter alia active material, in general also conducting carbon black and binder. The electronic conductivity is ensured by the conducting carbon black. The separator is comprised either of a neutral material, for example, a binder that is optionally stabilized by electrochemically inert insoluble particles (of SiO₂ or the like), as is known in the prior art. Into the binder instead or additionally also particles of a material can be embedded that is a solid-state electrolyte, such as Li_{1.3}Al_{0.3}Ti_{1.7}(PO₄)₃, LiTaO₃ x SrTiO₃, LiTi₂(PO₄)₃×Li₂O or Li₄SiO₄×Li₃PO₄, as disclosed in WO 01/41246 Al. Alternatively, for example, microperforated polymer films with a thickness of typically between 10 and 35 μm of polypropylene or polyethylene or compound films of both can be used. A further embodiment are nonwovens that are, for example, coated with ceramic material. The ionic conductivity in general is achieved by addition of a liquid electrolyte into the assembled cell. The electrolyte is comprised typically of a conducting salt that is dissolved in an organic solvent or a solvent mixture. This electrolyte can be worked into the individual films of the compound; preferably, however, it is absorbed into the layer composite after lamination of the individual layers, namely by the binder, for example, optionally assisted by the aforementioned insoluble particles, inasmuch as they are capable of improving the transport and storage of electrolyte liquid, by a concentration gradient of plasticizer in the binder and in the electrolyte, or by a microporous structure produced during film production (for example, obtained by removing plasticizer from the binder material), or by a mixture of two or all of the aforementioned effects.

The layers according to the invention are preferably present as films. For generating self-supporting layers (films, tapes) as well as of layers resting on a substrate, the conventional methods known in the prior art can be used that are suitable for the corresponding binder materials. Important techniques are the so-called tape casting, the so-called “reverse-roll-on-coating”, pouring, spraying, painting or rolling. The solidification of the matrix is realized, depending on the material, for example by curing (of resins or other pre-condensates as binder), by cross-linking of pre-polymerized products or linear polymerized products as binder, by evaporation of solvent, or in a similar way. In order to obtain self-supporting films, for example, a suitable pasty material can be formed on calander rollers in a suitable thickness. In this connection, reference is being had to standard technology. Self-supporting layers can also be produced by application of a pasty material on a substrate and pulling off the produced layer after it has solidified. The coating step can be carried out with conventional paste application methods. As examples, spreading, doctor blading, spraying, spin coating and the like are mentioned here. Printing techniques are also possible. Lamination of films to a composite is realized at a suitable temperature, for the conventional system PVDF, for example, in a suitable way at 100-250° C., preferably in the range of 135-150° C. Optionally, temperature gradients can be applied. Endless films can be laminated dynamic-continuously, for example, with a roll laminator. The linear load in this connection is preferably approximately 10-100 kg/cm.

The advantages of production by film technology are apparent: the film technology is a very economic manufacturing process that provides a high degree of freedom with regard to shaping. In addition to the possibility of rolling, also without great expenditure alternating other, even planar, geometries can be realized. Moreover, this technology ensures a very large contact surface between the individual layers of different functionality, for example, between electrodes and electrolyte in the accumulators relative to the employed volume of electrochemically active material. In connection with this application, this results in particularly favorable charging and discharging properties.

Preferably, a current collector is arranged indirectly or directly on the first layer (high energy layer). The reason for this is the charge carrier mobilities in the respective layers.

The ion mobility in the electrode is less than that of the electrons. A load imbalance that is caused by electronic displacement must be compensated by ion flow because otherwise an electrical field will be generated that will impair further electronic displacements within the electrode. When the current collector is arranged at the high energy layer that, as explained above, has a relatively high storage capacity but only a relatively minimal power density, i.e., release of charge carriers per time, charge displacements and imbalances can be compensated because there is sufficient time for charge compensation by ion flow. Preferably, the second layer is connected by means of the first layer with the current collector. A short-term high power density which occurs in pulse operation is effected by electron flow from the high power layer through the high energy layer to the current collector.

Preferably, the respective high energy and high power layers are intimately connected with each other so that advantageously no additional current conductor is required. The intimate connection can be realized in various ways. One possibility is to produce in separate tape casting processes first all layers separately and to then connect them with each other, and optionally a current conductor, by a lamination process, i.e., with application of pressure and temperature. Alternatively, it is possible to first completely process from start to finish a layer, for example, the high energy layer, by means of a tape casting process and, subsequently, by a second tape casting process to deposit it onto the other layer, i.e., in the exemplary situation, onto the high power layer. From the thus prepared electrode films the complete cell can then be produced either as a coiled round cell or as a prismatic stacked or coil cell.

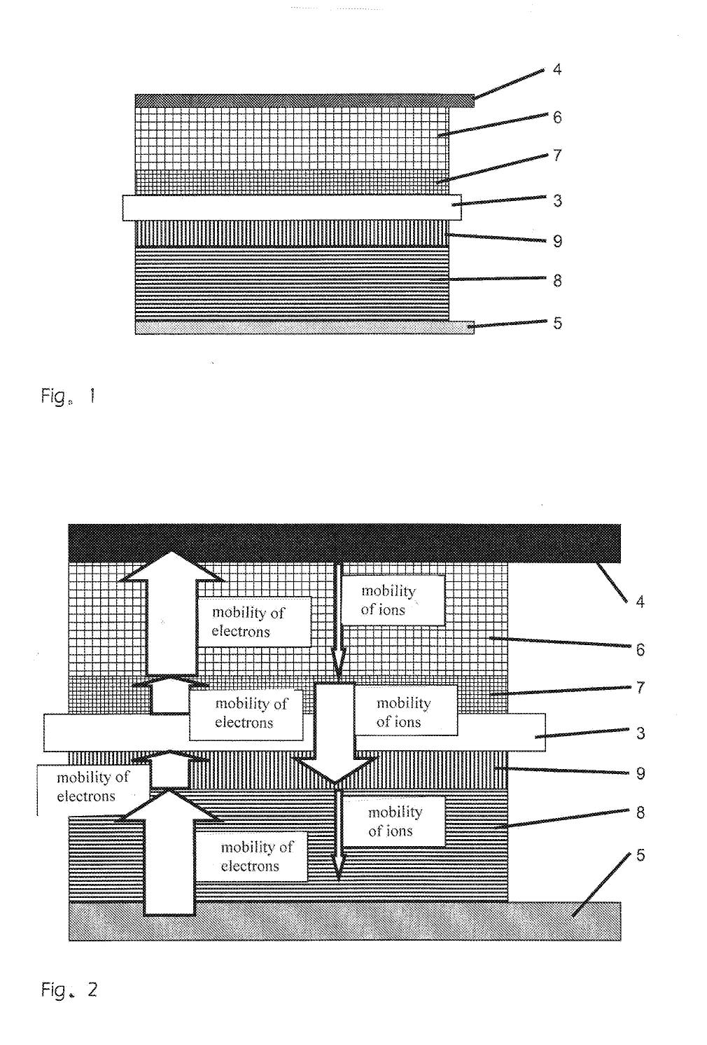

In FIG. 2, the current flows and the mobilities of the individual charge carriers in such a layer sequence is illustrated in an exemplary fashion during the discharge process. In this context, the abbreviations HL and HE stand for the flows in the high power layer and high energy layer. The stronger the arrow, the higher the required mobility of the charge carrier in the respective layer. Since the electrons in any case, i.e., at minimal load of the accumulator as well as at high power drain, must pass the entire circuit through the electrodes via the current conductor and to the counter electrode, a high electron conductivity in all layers (with the exception of the separator layer) is required. An increased ion conductivity is required only in that part of the layer system that is dimensioned with respect to high loadability.

In a further embodiment, the current collector is arranged between the first layer and the second layer. It preferably contacts directly the layers in this arrangement. The separator can be arranged between the second layer (high power layer) of the anode and the second layer of the cathode, preferably can be in direct contact with them. In this way, it is possible to advantageously shorten the electron travel distances through the films. With unchanged energy density in this way the power density of a storage element according to the invention is increased. The separator is a purely ion-conducting diaphragm that is introduced between anode and cathode as a thin separating layer. In general, it is either a micro-perforated diaphragm or a microporous diaphragm that are generated by combination of a filler material with a polymeric binder. By addition of electrolyte the ion conductivity in the separator is generated.

In particular in regard to the afore described embodiment it is advantageous when the current collector preferably of each electrode has an open-pore structure so that lithium ions can pass through the current collector. This can be achieved particularly well when the current conductor is substantially comprised of a perforated metal foil or a perforated expanded metal or the like. A disadvantage of this arrangement is however that the surface area for the passage of lithium ions is reduced by the open-pore current conductor and therefore the charge exchange between the high energy layer and the high power layer is slowed down. The current flows in this configuration for discharge are shown in an exemplary fashion in FIG. 4. Thickness and direction of the arrows symbolize here also the flow directions as well as the required mobilities of the charge carriers.

Further advantages and features of the present invention result from the following non-limiting description of exemplary embodiments with the aid of the drawings. It is shown in:

FIG. 1 a schematic section illustration of an electrochemical storage element;

FIG. 2 the electrochemical storage element of FIG. 1 with charge displacements being indicated;

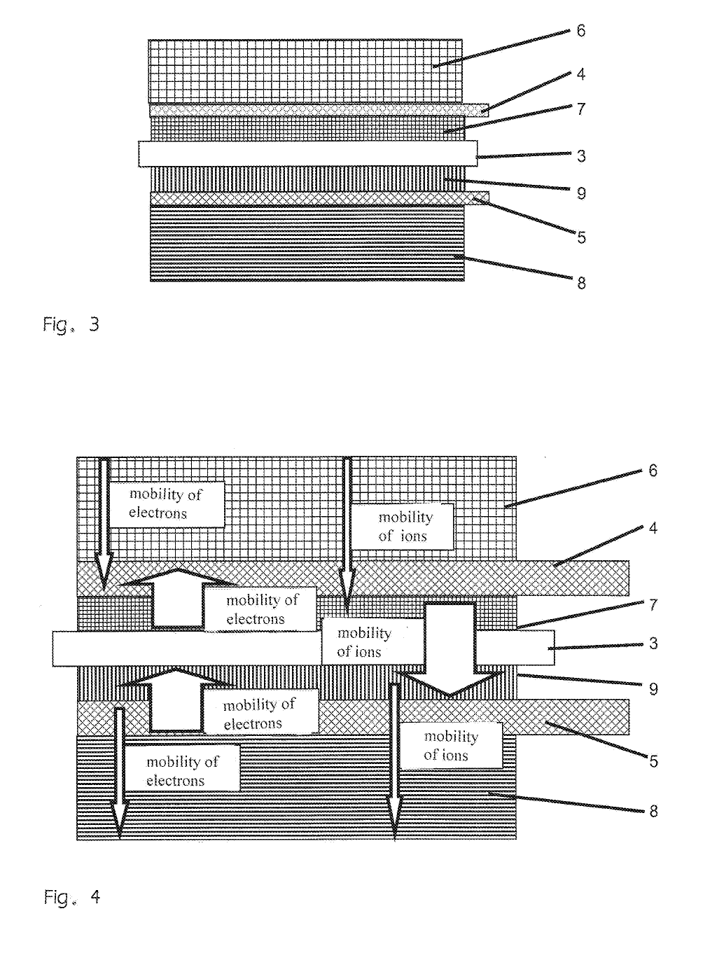

FIG. 3 another embodiment of an electrochemical storage element in a schematic section illustration;

FIG. 4 the electrochemical storage element of FIG. 3 with charge displacements being indicated; and

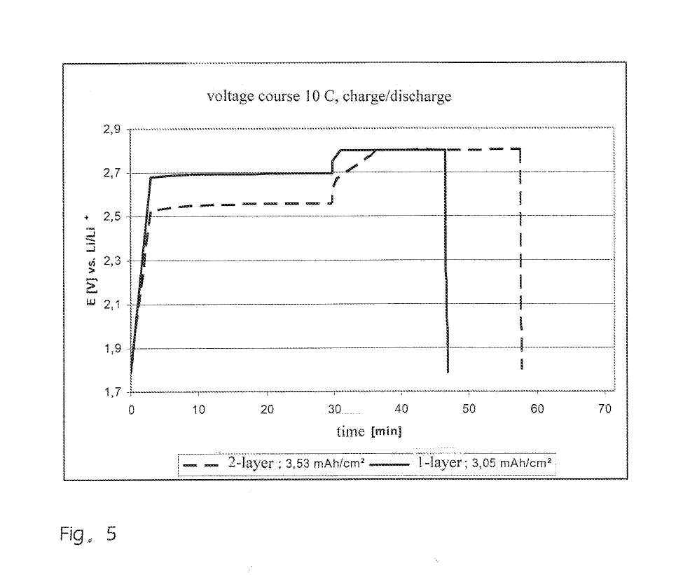

FIG. 5 a diagram of the voltage course over time during charging and discharging of a storage element according to the invention as well as of a conventional storage element.

In FIGS. 1 to 4, flat cells are illustrated as an example of the present invention. The first embodiment of a flat cell illustrated in FIG. 1 has an anode 1 and a cathode 2. Anode 1 and cathode 2 are separated from each other by a separator 3. The anode 1 is of a two-layer configuration and has an anode high energy layer 6 as well as an anode high power layer 7. In a similar way, the cathode 2 is also of a two-layer configuration and has a cathode high energy layer 8 as well as a cathode high power layer 9. The layers of anode 1 and cathode 2 are arranged such that the anode high power layer 7 as well as the cathode high power layer 9 adjoin the separator 3. On the side of the anode high power layer 7 or of the cathode high power layer 9 that is opposite the separator 3, the anode high energy layer 6 or the cathode high energy layer 8 is arranged.

On the side of the anode high energy layer 6 opposite the anode high power layer 7, an anode current collector 4 is arranged. On the side of the cathode high energy layer 8 opposite the cathode high power layer 9, a cathode current collector 5 is arranged. The current collectors 4, 5 serve for external contacting of the flat cell.

In the FIG. 2, the current flows and the mobilities of the charge carriers for each layer during the discharge process of the flat cell are illustrated. The strength of the illustrated arrows represents in this connection the required mobility of the charge carrier in the respective layer. The required mobility of the electrons is relatively high in all layers of the flat cell. The reason for this is that the electrons at minimal load as well as at high load of the flat cell must pass through the entire current circuit. The electron flow must be compensated by an appropriate ion flow. If this is not done, inner electrical fields are generated in the flat cell making difficult or weakening further charge displacements. In the layers that are designed for high loads, i.e., the anode high power layer 7 as well as the cathode high power layer 9, and in the purely ion-conducting separator 3 a high ion mobility is required in order to compensate the relatively large charge displacement by electrons and in order to prevent or minimize the generation of an electrical field in the high power layers 7, 9. In the anode high energy layer 6 and the cathode high energy layer 8 only a relatively minimal ion mobility is required because here only displacements of electrons of the respective high energy layer must be compensated.

The electron mobility in the high energy layers 6, 8 must be relatively high in order to allow passage of the relatively large charge quantities of the electrons originating from the respective high power layer 7, 8 through the respective high energy layer 6, 8.

In FIG. 3 an alternative embodiment of the flat cell is illustrated. It differs from the embodiment illustrated in FIGS. 1 and 2 by a different layer sequence. In the same way, an anode high power layer 7 as well as a cathode high power layer 9 are arranged adjoining the separator 3. Also, an anode high energy layer 6 as well as a cathode high energy layer 8 are provided. In contrast to the embodiment illustrated in FIGS. 1 and 2, the anode current collector 4 is however arranged between the anode high power layer 7 and the anode high energy layer 6 and the cathode current collector 5 between the cathode high power layer 9 and the cathode high energy layer 8. With this arrangement it is advantageously possible to shorten the electron travel distance through the film layers. This difference is apparent when looking at FIG. 3. Here the respective mobilities of the charge carriers are represented in a similar way as in FIG. 2. The required electron mobility and ion mobility in the high power layers 7, 9 are relatively high. As in the first embodiment illustrated in FIG. 2, the ion mobility in the respective high energy layers 6, 8 is relatively low. In contrast to this embodiment, also the electron mobility in the two high energy layers 6, 8 is low. The reason for this is that no electrons that are originating from the high power layers 7, 9 must pass through the high energy layers 6, 8 and the ion flow in the high energy layers 6, 8 must compensate only charge displacements by displacement of the electrons originating from the material of the high energy layers 6, 8.

In the following, an exemplary experimental design relating to the present invention will be described. Here cells with a 2-layer lithium titanate film in the negative electrode as well as with electrolytes based on LP30 (EC/DM 1:1, 1M LiPF₆) were produced and measured.

The positive electrode was produced in that PVDF as a binder (Kynar LBG2) was dissolved in acetone. To this solution lithium cobalt oxide powder (42% by weight) with an average particle size of 6 μm, graphite (2% by weight) and acetylene black (2% by weight) were then added, the mixture intimately mixed in a stirring device and processed to a viscous uniform paste. This paste was subsequently applied by means of a spreading blade onto a glass plate and the solvent was evaporated. The thus produced film had a charge per surface area of 3.5 mAh/cm² for a thickness of 120 μm.

The negative electrode had the two-layer configuration according to the invention. Its high energy layer was produced in that the binder PVDF (Kynar LBG2) was dissolved in acetone. Subsequently, Li₄Ti₅O₁₂ (28% by weight) and acetylene black (5% by weight) were added and intimately mixed with each other. The added lithium titanate is a high energy material with an average primary particle size of approximately 1 μm and a minimal degree of agglomeration. The thus obtained pasty material was applied by means of a spreading blade onto a glass plate and the solvent was evaporated. The thus produced film had a thickness of 140 μm and a capacity per surface area of 2.6 mAh/cm².

The high power layer was produced in that the binder PVDF (Kynar LBG2) was dissolved in acetone. Subsequently, Li₄Ti₅O₁₂ (25% by weight) and acetylene black (5% by weight) were added and intimately mixed with each other. The added lithium titanate is a high power material; this is reflected by a significantly reduce average primary particle size of approximately 500 nm and an increased degree of agglomeration relative to the lithium titanate used in the high energy layer. This agglomeration leads to an excellent processibility while maintaining the properties of the very small primary particles. The capacity per surface area of the film designed for high loadability was 0.9 mAh/cm², the layer thickness 118 μm.

Both films (high power layer, high energy layer) were connected to each other after the drying process by means of a roll laminator and a linear load of 120 kg/cm at a temperature of 155° C.

For the separator layer 75% by weight of Li_{1.3}Al_{0.3}Ti_{1.7}(PO₄)₃ powder was intimately mixed with PVDF (25% by weight) dissolved in acetone and spread to a film with a thickness of approximately 50 μm. As electrolyte a 1M solution of the conducting salt LiPF₆ in a mixture of ethylene carbonate (EC) and dimethyl carbonate (DMC) 1:1 (standard electrolyte, type designation LP30) was used.

In this example, the current collector in accordance with FIG. 1 was attached. The lamination to the cell body was realized by means of static lamination at a temperature of 160° C. and a pressure of 1.9 MPa. The battery body was hermetically fused into a metallized plastic film. This method is known to a person of skill in the art as pouch or coffee bag technology.

As a reference a second cell was constructed whose electrodes did not have a multi-layer configuration, respectively. Their positive electrode was produced in that PVDF as binder (Kynar LBG2) was dissolved in acetone. To this solution, lithium cobalt oxide powder (42% by weight), graphite (2% by weight) and acetylene black (2% by weight) were then added, everything intimately mixed in a stirring device and processed to a viscous uniform paste. This paste was subsequently applied by means of a spreading blade to a glass plate and the solvent was evaporated. The thus produced film had a charge per surface area of 3.05 mAh/cm² and a thickness of 103 μm.

The negative electrode was produced in that the same binder PVDF (Kynar LBG2) was dissolved in acetone. Subsequently, Li₄Ti₅O₁₂ (28% by weight) with an average particle size of 1 μm and acetylene black (1.7% by weight) were added and intimately mixed with each other. The thus obtained paste was subsequently applied by means of a spreading blade onto a glass plate and the solvent was evaporated. The capacity at 3.1 mAh/cm² was matched to the cathode capacity, the thickness was 165 μm.

For the separator layer 75% by weight of Li_{1.3}Al_{0.3}Ti_{1.7}(PO₄)₃ powder was intimately mixed with PVDF (25% by weight) dissolved in acetone and spread to a film of a thickness of approximately 50 μm.

From these films test cells were produced also with a standard electrolyte LP30, wherein anode, separator and cathode before electrolyte addition were fused to each other with a static laminator at 160° C. and a pressure of 1.9 MPa.

The cells after their manufacture were packaged by pouch technology known to a person of skill in the art and tested comparatively with respect to their electrical behavior. FIG. 5 shows the voltage course of both test cell types after multiple charge/discharge loads with 10C (charge or discharge within 6 min; 1/10 of an hour). At the end of each discharge the cells are discharged to 1.8 V. This is the starting point on the voltage axis in FIG. 5. By diffusion-caused compensation processes that are caused by the internal resistance of the cell and recuperation of the cell balance, after complete discharge to 1.8 V the voltage will increase again slowly in the rest phase until the next charging step occurs. The higher the internal resistance, the higher the voltage increase. For the thick 2-layer electrodes (referenced as 2-layer in FIG. 5) the voltage jumps to approximately 2.55 V while for the thinner 1-layer electrode structure (identified as 1-layer in FIG. 5) within the same time the voltage increases to approximately 2.7 V. This is a surprising result because, based on prior art knowledge, the exact opposite behavior is to be expected because the thick electrodes cause an increased internal resistance. When a charging process is started after the rest phase of 30 minutes, the voltage in the 1-layer system increases much faster in comparison to the 2-layer system which is also contrary to the expected behavior. This is all the more surprising as the measurement of the internal resistance by means of impedance spectroscopy provides no indication of a significantly improved behavior of the 2-layer system under high load. The 2-layer cell has at 1 kHz an impedance of 808 mΩ and the 1-layer cell 793.3 mΩ. This difference is so minimal that no significantly different electrical behavior in particular with regard to load was to be expected.

### LIST OF REFERENCE NUMERALS

1 anode
2 cathode
3 separator
4 current collector of anode
5 current collector of cathode
6 anode high energy layer A
7 anode high power layer K
8 cathode high energy layer A
9 cathode high-power layer K
10 arrow for electron mobility
11 arrow for ion mobility

What is claimed is:

1-16. (canceled)

17. An electrode layer composite for forming flat electrodes for electrochemical storage elements, the electrode layer composite comprising:
a first layer containing a first electrode material,
a second layer containing a second electrode material;
wherein said first and second electrode materials are chemically identical;
wherein said first layer has a higher specific capacity than said second layer;
wherein said second layer has a higher power density or ampacity per surface area than said first layer.

18. The electrode layer composite according to claim 17, wherein said first layer has a greater layer thickness than said second layer.

19. The electrode layer composite according to claim 17, wherein said first electrode material is in the form of first particles and said second electrode material is in the form of second particles, wherein said first particles have a greater particle diameter than said second particles.

20. The electrode layer composite according to claim 19, wherein said particle diameter of said first particles is 1.5 times to 7.5 times greater than said particle diameter of said second particles.

21. The electrode layer composite according to claim 17, wherein said first and second layers each contain a binder.

22. The electrode layer composite according to claim 21, wherein said binder contains a polymer material and optionally a plasticizer.

23. The electrode layer composite according to claim 17 in the form of a film composite.

24. An electrochemical storage element for storing as well as delivering electrical energy, comprising:
a flat anode;
a separator;
a flat cathode;
wherein at least one of said anode and said cathode comprises an electrode layer composite comprising:
a first layer containing a first electrode material,
a second layer containing a second electrode material,
wherein said first and second electrode materials are chemically identical;
wherein said first layer has a higher specific capacity than said second layer;
wherein said second layer has a higher power density or ampacity per surface area than said first layer.

25. The electrochemical storage element according to claim 24, wherein said separator is arranged between said second layer of said anode and said second layer of said cathode.

26. The electrochemical storage element according to claim 25, wherein said separator is in direct contact with said second layer of said anode and said second layer of said cathode.

27. The electrochemical storage element according to claim 24, further comprising a flat current collector, wherein said current collector has an open-pore structure so that lithium ions can pass through said current collector.

28. The electrochemical storage element according to claim 27, wherein said current collector is a perforated metal film or an expanded meta I.

29. A method for producing an electrode layer composite, comprising a first layer containing a first electrode material and a second layer containing a second electrode material wherein said first and second electrode materials are chemically identical; wherein said first layer has a higher specific capacity than said second layer; wherein said second layer has a higher power density or ampacity per surface area than said first layer; the method comprising the steps of:
separately producing said first layer and said second layer;
laminating subsequently said first layer and said second layer by application of at least one of pressure and temperature.

30. A method for producing an electrode layer composite, comprising a first layer containing a first electrode material and a second layer containing a second electrode material wherein said first and second electrode materials are chemically identical; wherein said first layer has a higher specific capacity than said second layer; wherein said second layer has a higher power density or ampacity per surface area than said first layer; the method comprising the steps of:
a) tape casting one of said first and second layers as an initial layer;
b) subsequently depositing the other one of said first and second layers by tape casting onto said initial layer of step a).

31. A method for producing an electrochemical storage element comprising a flat anode, a separator, and a flat cathode, wherein at least one of said anode and said cathode comprises an electrode layer composite comprising a first layer containing a first electrode material and a second layer containing a second electrode material wherein said first and second electrode materials are chemically identical; wherein said first layer has a higher specific capacity than said second layer; wherein said second layer has a higher power density or ampacity per surface area than said first layer; the method comprising the steps of:
separately producing said first layer and said second layer;
laminating subsequently said first layer and said second layer by application of at least one of pressure and temperature.

32. A method for producing an electrochemical storage element comprising a flat anode, a separator, and a flat cathode, wherein at least one of said anode and said cathode comprises an electrode layer composite comprising a first layer containing a first electrode material and a second layer containing a second electrode material wherein said first and second electrode materials are chemically identical; wherein said first layer has a higher specific capacity than said second layer; wherein said second layer has a higher power density or ampacity per surface area than said first layer; the method comprising the steps of
a) tape casting one of said first and second layers as an initial layer;
b) subsequently depositing the other one of said first and second layers by tape casting onto said initial layer of step a).

33. The electrode layer composite according to claim 23, further comprising a flat current collector arranged directly or indirectly on said first layer.

34. The electrode layer composite according to claim 33, wherein said second layer is connected through said first layer to said flat current collector.

35. The electrode layer composite according to claim 33, wherein said flat current collector is arranged between said first layer and said second layer.

36. The electrode layer composite according to claim 35, wherein said flat current collector directly contacts said first layer and said second layer.
